(19) United States
(12) Patent Application Publication
(10) Pub. No.: US 2026/0073233 A1
(43) Pub. Date: Mar. 12, 2026

(54) REINFORCEMENT LEARNING DEVICE, REINFORCEMENT LEARNING METHOD, AND RECORDING MEDIUM

(71) Applicant: HITACHI, LTD., Tokyo (JP)

(72) Inventors: Koki Takeshita, Tokyo (JP); Naoyuki Terashita, Tokyo (JP)

(73) Assignee: HITACHI, LTD., Tokyo (JP)

(21) Appl. No.: 19/273,795

(22) Filed: Jul. 18, 2025

(30) Foreign Application Priority Data
Aug. 9, 2024 (JP) 2024-134427

(51) Int. Cl. G06N 3/092

(52) U.S. Cl. CPC G06N 3/092

(57) ABSTRACT

To reduce difficulty in learning. A reinforcement learning device includes: a generation unit configured to generate a behavior of an environment; a calculation unit configured to calculate, based on an action on the environment and the behavior generated by the generation unit, a mimicry reward indicating how much the action mimics the behavior; a collection unit configured to select the action on the environment based on a policy and collect experience data including the action, a state of the environment when the action is performed on the environment, and a reward obtained from the environment as a result of performing the action; and a learning unit configured to learn the policy based on the reward collected by the collection unit and the mimicry reward calculated by the calculation unit.

### CLAIM OF PRIORITY

The present application claims priority from Japanese patent application No. 2024-134427 filed on Aug. 9, 2024, the content of which is hereby incorporated by reference into this application.

### BACKGROUND OF THE INVENTION

### 1. Field of the Invention

The present invention relates to a reinforcement learning device, a reinforcement learning method, and a reinforcement learning program for performing reinforcement learning.

### 2. Description of Related Art

Development of autonomous agents in reinforcement learning requires an appropriate environment in which it is possible to quickly evaluate various alternatives, in particular, how to implement a training scenario in which an attacker and a defender compete against each other.

The following NPL 1 discloses CyberBattleSim. CyberBattleSim has a function of training attack artificial intelligence (AI) and a function of training defense AI. Training the defense AI enhances the defense against the attack. In particular, when the defense AI is trained together with the attack AI, the defense capability of the defense AI for preventing an advanced attack from the attack AI is improved.

### CITATION LIST

### Non Patent Literature

NPL 1: Thomas Kunz, Christian Fisher, James La Novara-Gsell, Christopher Nguyen, Li Li, “A Multiagent CyberBattleSim for RL Cyber Operation Agents” https://arxiv.org/pdf/2304.11052.pdf, 3 Apr. 2023

### SUMMARY OF THE INVENTION

During training, if learning in which no reward is obtained or only a low reward is obtained continues until a high reward is obtained, that is, learning in which a sparse reward is obtained continues, learning becomes difficult. As a result, since the defense AI overwhelms the attack AI at the initial stage of learning, it is difficult to collect good experience data necessary for learning.

An object of the invention is to reduce difficulty in learning.

A reinforcement learning device which is one aspect of the invention disclosed in the present application includes: a generation unit configured to generate a behavior of an environment; a calculation unit configured to calculate, based on an action on the environment and the behavior generated by the generation unit, a mimicry reward indicating how much the action mimics the behavior; a collection unit configured to select the action on the environment based on a policy and collect experience data including the action, a state of the environment when the action is performed on the environment, and a reward obtained from the environment as a result of performing the action; and a learning unit configured to learn the policy based on the reward collected by the collection unit and the mimicry reward calculated by the calculation unit.

According to a typical embodiment of the invention, difficulty in learning can be reduced. Problems, configurations, and effects other than those described above will be clarified by descriptions of the following embodiment.

### BRIEF DESCRIPTION OF THE DRAWINGS

FIG. 1 is a block diagram illustrating a hardware structure example of a reinforcement learning device.

FIG. 2 is a diagram illustrating an example of a reinforcement learning process.

FIG. 3 is a diagram illustrating a problem setting example 1 in reinforcement learning.

FIG. 4 is a diagram illustrating a problem setting example 2 in reinforcement learning.

FIG. 5 is a block diagram illustrating a functional configuration example 1 of the reinforcement learning device.

FIG. 6 is a block diagram illustrating a detailed functional configuration example of the attack experience collection unit.

FIG. 7 is a table illustrating selection results of the priority ai by the UCB method.

FIG. 8 is a graph illustrating a setting example of the priority.

FIG. 9 is a block diagram illustrating a detailed functional configuration example of the attack learning unit.

FIG. 10 is a block diagram illustrating a functional configuration example of the reinforcement learning device.

### DESCRIPTION OF EMBODIMENTS

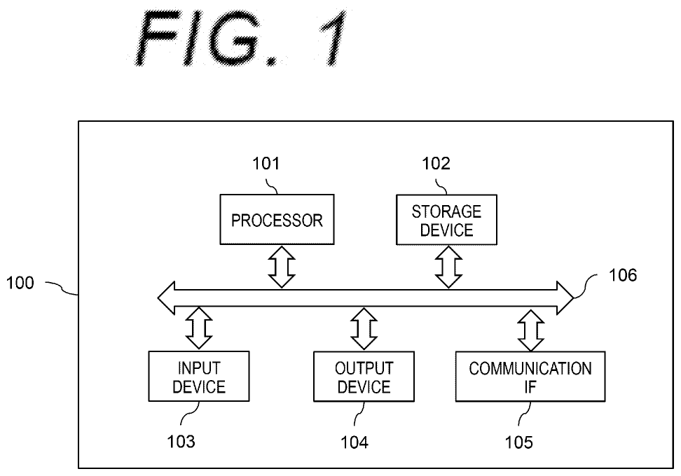

FIG. 1 Hardware Structure Example of Reinforcement Learning Device

FIG. 1 is a block diagram illustrating a hardware structure example of a reinforcement learning device. A reinforcement learning device 100 includes a processor 101, a storage device 102, an input device 103, an output device 104, and a communication interface (communication IF) 105. The processor 101, the storage device 102, the input device 103, the output device 104, and the communication IF 105 are connected to one another by a bus 106. The processor 101 controls the reinforcement learning device 100. The storage device 102 is a work area of the processor 101. The storage device 102 is a non-transitory or transitory recording medium that stores various programs or data. Examples of the storage device 102 include a read only memory (ROM), a random access memory (RAM), a hard disk drive (HDD), and a flash memory. The input device 103 inputs data. Examples of the input device 103 include a keyboard, a mouse, a touch panel, a numeric keypad, a scanner, a microphone, and a sensor. The output device 104 outputs data. Examples of the output device 104 include a display, a printer, and a speaker. The communication IF 105 is connected to a network to transmit and receive data.

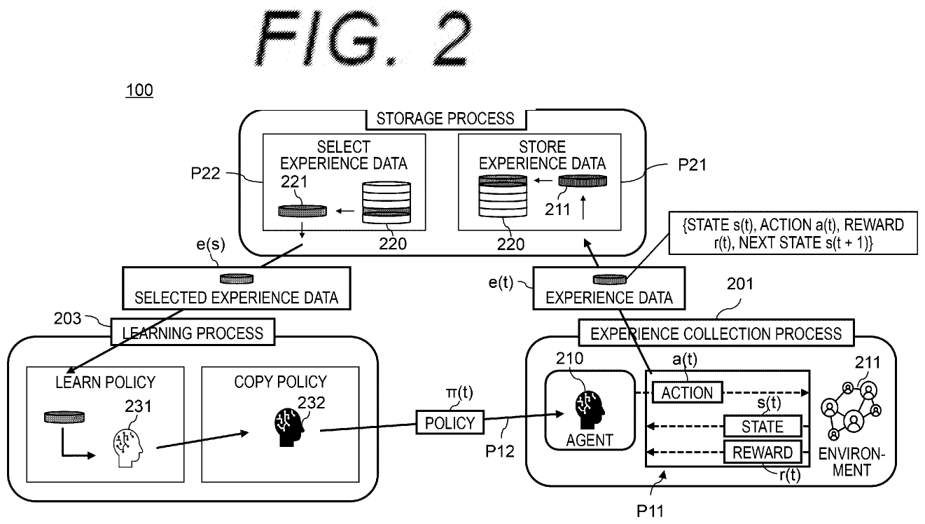

### FIG. 2 Reinforcement Learning Process

FIG. 2 is a diagram illustrating an example of a reinforcement learning process. In reinforcement learning, the reinforcement learning device 100 repeatedly executes an experience collection process 201, an experience storage process 202, and a learning process 203 asynchronously, as follows: the experience collection process 201→the experience storage process 202→the learning process 203→the experience collection process 201→the experience storage process 202→the learning process 203 . . . .

Specifically, the experience collection process 201, the experience storage process 202, and the learning process 203 are realized, for example, by causing the processor 101 to execute the program stored in the storage device 102. Hereinafter, the experience collection process 201, the experience storage process 202, and the learning process 203 will be specifically described.

### Experience Collection Process 201

In the experience collection process 201, the following P11 and P12 are repeated. Note that t shown below is the number of time steps and is an integer in ascending order starting from 0. That is, the number of time steps t is the number of repetition times of learning, t is incremented when the learning process 203 is executed, and the reinforcement learning ends when t reaches a predetermined value.

P11: An agent 210 observes a current state s(t) of an environment 211, executes an action a(t) selected according to a policy n(t) of the agent 210 on the environment 211, and obtains a reward r(t) obtained as a result of the action a(t) and the next state s(t+1). The agent 210 sends {state s(t), action a(t), reward r(t), next state s(t+1)} to the experience storage process 202 as experience data e(t).

The reward r(t) is a reward obtained when the state transitions to the state s(t+1) by taking the action a(t) in the state s(t).

P12: The agent 210 receives a latest policy π(t) from the learning process 203 at regular intervals and updates the policy π(t) of the agent 210.

### Experience Storage Process 202

In the experience storage process 202, the following P21 and P22 are repeated.

P21: The reinforcement learning device 100 receives the experience data e(t) collected by the experience collection process 201, calculates a priority of the experience data e(t), and accumulates the priority in the storage device 102. The priority of the experience data e(t) is calculated using an index called a temporal difference (TD) error that increases as the experience data e(t) has a higher learning value. There are a plurality of methods for determining the priority of the experience data e(t) from the TD error, and there is proportinal as a representative method, and an absolute value of the TD error is defined as the priority of the experience data e(t). However, since the priority of the experience data e(t) needs to be a probability distribution, a total value of the priorities of all the experience data e(t) is normalized to 1.

P22: As soon as there is a request from the learning process 203, the reinforcement learning device 100 selects the experience data e(t) from an accumulated experience data group 220 based on the priority of the experience data e(t). The experience data e(t) selected is referred to as selected experience data e(s). The selected experience data e(s) is not limited to the experience data e(t) of the number of time steps t. The reinforcement learning device 100 sends the selected experience data e(s) to the learning process 203.

### Learning Process 203

In the learning process 203, the following P31 and P32 are repeated.

P31: An agent 231 before learning the latest policy π(t) learns a policy π(t−1), receives the selected experience data e(s) from the experience storage process 202, and learns the latest policy π(t) based on the selected experience data e(s). The policy π(t) is a probability of causing the action a(t) in the state s(t). The agent 231 has the same configuration as the agent 210.

P32: The agent 231 (hereinafter, agent 232) that has learned the latest policy π(t) sends the latest policy π(t) to the experience collection process 201 at regular intervals.

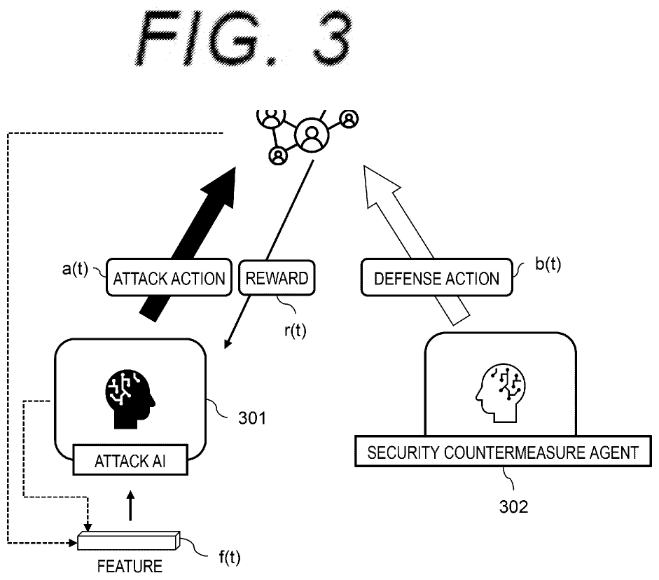

### FIG. 3 Problem Setting Example 1 in Reinforcement Learning

FIG. 3 is a diagram illustrating a problem setting example 1 in reinforcement learning. In embodiment 1, the attack AI 301 performs a cyber attack on the environment 211, and a security countermeasure agent 302 defends the cyber attack from the attack AI 301.

The environment 211 is a network simulator including a plurality of nodes and links connecting the nodes. For example, the environment 211 is a simulator that simulates a behavior in an intra-organization network indicating a human relation in an organization, a node indicates a personal computer handled by a person or a server in the organization, and a link indicates a relation between persons, a connection relation between personal computers handled by persons, or a connection relation between a personal computer and a server.

The security countermeasure agent 302 is, for example, inherent security countermeasure software implemented in the environment 211, and is executed by the processor 101. A network state of the environment 211 before a defense action b(t) executed by the security countermeasure agent 302 is the state s(t) in FIG. 2, and a network state of the environment 211 after the defense action b(t) executed by the security countermeasure agent 302 in response to an attack action a(t) is the next state s(t+1).

The attack AI 301 indicates the agents 210, 231, and 232 that repeat the experience collection process 201, the experience storage process 202, and the learning process 203 illustrated in FIG. 2 to execute the cyber attack on the environment 211 and learn the cyber attack. Specifically, for example, the attack AI 301 executes the attack action a(t) on the environment 211 as the agent 210 to acquire the reward r(t), thereby collecting the experience data e(t).

A goal of the attack AI 301 is to acquire ownership of all nodes in the network implemented by the environment 211, for example, to acquire a login ID and a password of a personal computer or a server or to infect the network with malware. Therefore, the reward r(t) depends on the next state s(t+1) of the environment 211, for example, r=50 when new authority is obtained and r=5000 when authority of all nodes is obtained.

The attack AI 301 learns, as the agent 231, the policy π(t) that defines an attack, that is, a selection method of the action a(t) based on the selected experience data e(s).

A feature f(t) is input to the attack AI 301. The feature f(t) is a vector indicating an attack result such as the number of nodes acquired from the environment 211, the number of nodes discovered, and cache information of an intra-organization network.

In the experience collection process 201, when receiving the feature f(t), the attack AI 301 calculates an expected value of a future cumulative reward when each of the plurality of attack actions a(t) is performed according to the policy π(t), and outputs a vector storing the expected value of the cumulative reward. The expected value of the cumulative reward is a sum of expected values of rewards r(t), r(t+1), r(t+2) . . . to be obtained in the future (addition until an end condition of the environment 211 (for example, acquisition of ownership of all nodes) is satisfied). The expected value of the cumulative reward is calculated by a state value function.

The attack AI 301 refers to the expected value of the cumulative reward of each attack action a(t), selects an attack action a(t) with a high expected value of the cumulative reward, that is, an attack action a(t) with which a higher reward r(t) is likely to be obtained (=good) from among the plurality of attack actions a(t), and attacks the environment 211. By this attack action a(t), the state s(t) of the environment 211 transitions to the next state s(t+1).

In the learning process 203, the attack AI 301 optimizes parameters of the attack AI 301 based on the selected experience data e(s) so that the cumulative reward can be accurately predicted. The parameter here is a policy π when the state s(t) is input, and for example, the parameter is optimized by minimizing the TD error of the experience data e(t). Specifically, for example, the attack AI 301 learns the policy π(t) so as to maximize the expected value of the cumulative reward.

The environment 211 receives the attack action a(t) and the defense action b(t), rewrites the state s(t) inside the intra-organization network to the next state s(t+1), and passes the reward r(t) calculated based on a reward rule as well as the feature f(t) to the attack AI 301. The reward rule is basically designed to output a high reward when a desirable state is obtained (when the game is won). For example, in a case in which CyberBattleSim is used, when one ownership of a node in the environment 211 (a device in the network) is acquired, a reward of about 10 to 100 is obtained according to the importance of the node. When the ownership of all the nodes is obtained, a reward of 5000 is obtained, and the game ends.

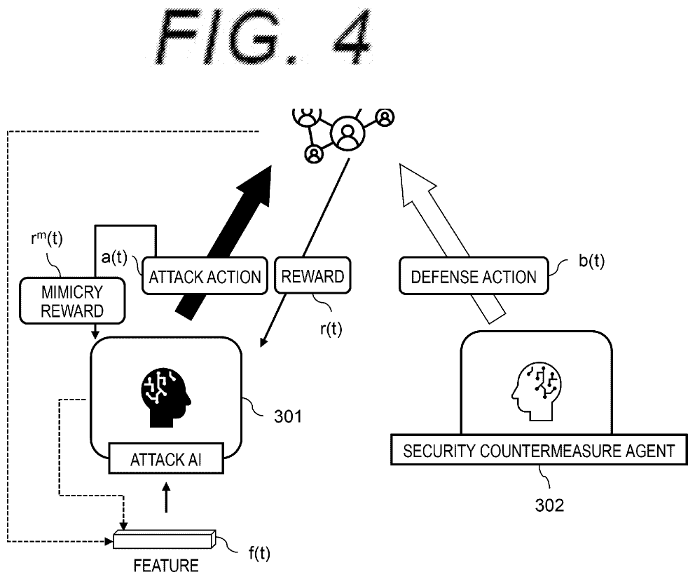

### FIG. 4 Problem Setting Example 2 in Reinforcement Learning

FIG. 4 is a diagram illustrating a problem setting example 2 in reinforcement learning. FIG. 4 illustrates a configuration in which a mimicry reward r^{m}(t) is added to the problem setting example 1 in FIG. 3. The mimicry reward r^{m}(t) is an index value for evaluating whether a normal action in the environment 211 can be imitated. That is, if the normal action in the environment 211 is imitated, the attack action a(t) is more likely to infiltrate the intra-organization network without being detected by the security countermeasure agent 302.

The attack AI 301 calculates an expected value Q^{s}(t) of a cumulative value of a combined reward r^{s}(t), which is a value obtained by adding the reward r(t) and the mimicry reward r^{m}(t) weighted by a priority α(t) calculated by the attack AI 301. That is, as the mimicry reward r^{m}(t) increases (as the normal action can be imitated), the expected value Q^{s}(t) of the cumulative combined reward also increases. Therefore, in the experience collection process 201, the attack AI 301 can learn the probability of selecting such an action a(t), that is, the policy π(t), by calculating the expected value Q^{s}(t) of the cumulative combined reward.

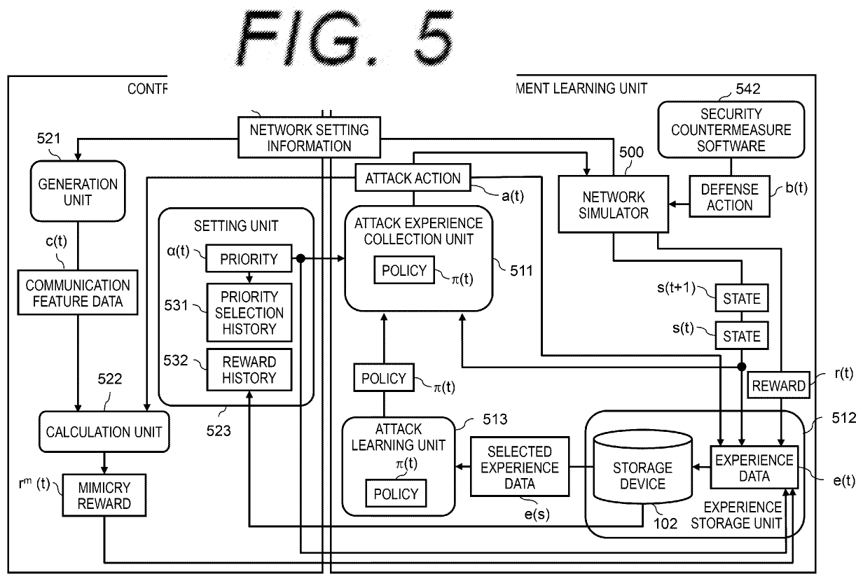

### FIG. 5 Functional Configuration Example 1 of Reinforcement Learning Device 100

FIG. 5 is a block diagram illustrating a functional configuration example 1 of the reinforcement learning device 100. The reinforcement learning device 100 includes a reinforcement learning unit 501 and a control unit 502. Specifically, the reinforcement learning unit 501 and the control unit 502 are implemented, for example, by causing the processor 101 to execute the program stored in the storage device 102 illustrated in FIG. 1.

The state s(t) illustrated in FIG. 5 corresponds to the feature f(t) illustrated in FIGS. 3 and 4. That is, a vector obtained by quantifying the state s(t) is the feature f(t), and the conversion from the state s(t) to the feature f(t) is executed by the policy π(t).

### Reinforcement Learning Unit 501

The reinforcement learning unit 501 includes an attack experience collection unit 511, an experience storage unit 512, and an attack learning unit 513. The attack experience collection unit 511, as the attack AI 301, executes the above-described experience collection process 201 on a network simulator 500, which is an example of the environment 211, selects the attack action a(t) based on the policy π(t), and attacks the network simulator 500. A security countermeasure software 542 is an example of the security countermeasure agent 302, and causes the network simulator 500 to take a defense action b(t) with respect to the attack action a(t).

The network simulator 500 outputs the state s(t) before the attack action a(t) and the next state s(t+1) after the defense action b(t) against the attack action a(t). The network simulator 500 outputs the reward r(t) obtained when the attack experience collection unit 511 takes the attack action a(t) in the state s(t) and transitions to the state s(t+1) based on the reward rule described above.

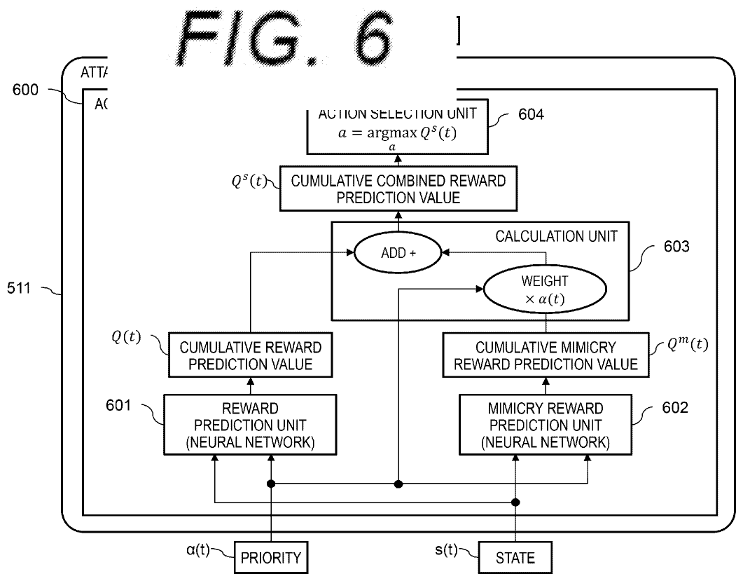

When the priority α(t) is input from a setting unit 523, the attack experience collection unit 511 outputs the attack action a(t) based on the priority a(t) and the policy π(t). Details of the attack experience collection unit 511 will be described later with reference to FIG. 6.

The experience storage unit 512, as the attack AI 301, executes the experience collection process 201 described above. Although {state s(t), action a(t), reward r(t), next state s(t+1)} is stored in the experience data e(t) in the experience collection process 201 described above, the mimicry reward r^{m}(t) and the priority α(t) are also stored here.

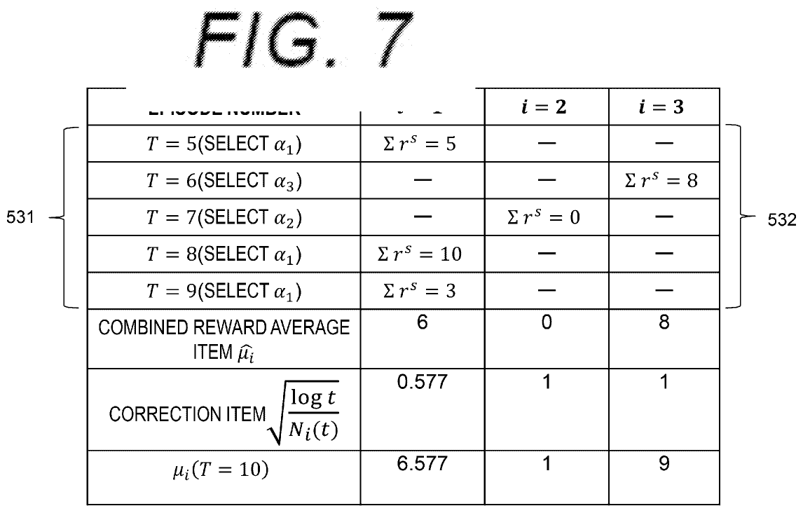

The attack learning unit 513, as the attack AI 301, executes the above-described learning process 203 based on the selected experience data e(s), generates the policy π(t), and outputs the policy π(t) to the attack experience collection unit 511. Details of the attack learning unit 513 will be described later with reference to FIG. 7.

### Control Unit 502

The control unit 502 controls the reinforcement learning unit 501 to generate the mimicry reward r^{m}(t). Specifically, for example, the control unit 502 includes a generation unit 521, a calculation unit 522, and the setting unit 523.

The generation unit 521 uses network setting information 514 from the network simulator 500 to generate, as the behavior of the environment 211, communication feature data c(t) indicating communication flowing through the intra-organization network implemented by the network simulator 500.

The network setting information 514 includes nodes constituting an intra-organization network, types of nodes (personal computers/servers), the number of nodes n (n is an integer of 1 or more), and links connecting the nodes.

The communication feature data c(t) is data in which the number of times of communication from the i-th (i is an integer satisfying 1≤i≤n) node to the j-th (j is an integer satisfying 1≤j≤n) node in the number of time steps t is stored in an element (hereinafter, an element ij) of the i-th row and the j-th column of an n×n matrix. That is, the communication feature data c(t) is communication (normal communication) indicating a normal action in the network simulator 500.

The calculation unit 522 calculates the mimicry reward r^{m}(t) based on the communication feature data c(t) and the attack action a(t). The attack action a(t) is data in which the number of times of communication from the i-th node to the j-th node generated by an attack on the network simulator 500 is further stored in the element ij in the communication feature data c(t).

The mimicry reward r^{m}(t) is, for example, the reciprocal of the Euclidean distance between the communication feature data c(t) and the attack action a(t), and indicates a similarity between the normal communication and the attack action a(t). In order to avoid the denominator becoming 0, a constant (for example, 1) may be added to the denominator. The shorter the Euclidean distance between the communication feature data c(t) and the attack action a(t) (the larger the mimicry reward r^{m}(t)), the more similar the normal communication indicated by the communication feature data c(t) and the communication indicated by the attack action a(t), and the attack action a(t) can imitate the normal communication indicated by the communication feature data c(t). Therefore, such an attack action a(t) is more likely to infiltrate the intra-organization network without being detected by the security countermeasure agent 302. The mimicry reward r^{m}(t) is stored in the experience data e(t).

The setting unit 523 sets the priority α(t) indicating how much priority is given to the mimicry reward r^{m}(t), and outputs the priority α(t) to the attack experience collection unit 511. Specifically, for example, the setting unit 523 sets the priority α(t) using a priority selection history 531 and/or a reward history 532. The priority selection history 531 is a history in which priorities a (1) to α(t−1) up to the number of time steps t-1 are selected. The reward history 532 is a calculation history of the rewards r (1) to r(t−1) up to the number of time steps t-1.

### FIG. 6 Attack Experience Collection Unit 511

FIG. 6 is a block diagram illustrating a detailed functional configuration example of the attack experience collection unit 511. The attack experience collection unit 511 includes an action determination unit 600. The action determination unit 600 includes a reward prediction unit 601, a mimicry reward prediction unit 602, a calculation unit 603, and an action selection unit 604.

The reward prediction unit 601 is a neural network that receives the priority α(t) and the state s(t) and calculates a cumulative reward prediction value Q(t). The mimicry reward prediction unit 602 is a neural network that receives the priority α(t) and the state s(t) and calculates a cumulative mimicry reward prediction value Q^{m}(t). That is, the policy π(t) is a weight set in the reward prediction unit 601 and the mimicry reward prediction unit 602.

The cumulative reward prediction value Q(t) is an expected value of a future cumulative reward when each of the plurality of attack actions a(t) is performed. The cumulative mimicry reward prediction value Q^{m}(t) is an expected value of a future cumulative mimicry reward when each of the plurality of attack actions a(t) is performed. That is, the cumulative reward prediction value Q(t) and the cumulative mimicry reward prediction value Q^{m}(t) are real vectors having dimensions corresponding to the number of attack actions a(t), and the expected value when the attack action is executed is stored for each dimension.

The calculation unit 603 weights the cumulative mimicry reward prediction value Q^{m}(t) with the priority α(t) and adds the cumulative reward prediction value Q(t) and the weighted cumulative mimicry reward prediction value Q^{m}(t)×α(t) to output a cumulative combined reward prediction value Q^{s}(t). When the learning ends and the inference is executed, the calculation unit 603 calculates the cumulative combined reward prediction value Q^{s}(t) with the priority α(t)=0. That is, the cumulative mimicry reward prediction value Q^{m}(t) is used only for collecting good experience at the time of experience collection at the time of learning.

The action selection unit 604 selects the attack action a(t) based on the cumulative combined reward prediction value Q^{s}(t). Specifically, for example, the action selection unit 604 selects the action a(t) that maximizes the cumulative combined reward prediction value Q^{s}(t). The cumulative combined reward prediction value Q^{s}(t) is also a real vector having dimensions corresponding to the number of attack actions a(t), similarly to the cumulative reward prediction value Q(t) and the cumulative mimicry reward prediction value Q^{m}(t). The action selection unit 604 selects the attack action a(t) that maximizes the cumulative combined reward prediction value Q^{s}(t) from the real vector of the cumulative combined reward prediction value Q^{s}(t).

The priority a(t) input to the reward prediction unit 601 and the mimicry reward prediction unit 602 is selected according to, for example, an upper confidence bound (UCB) method. The UCB method is a method of selecting which hyperparameter (priority ai in this example) is used to collect experiences in reinforcement learning. i indicates any one of numbers 1 to n (n is an integer of 1 or more) in the priority selection history 531.

Based on the reward history 532 obtained in the latest several episodes, the setting unit 523 selects the priority ai as the priority α(t) in consideration of the following points (A) and (B).
(A) The setting unit 523 selects the priority xi with which as many rewards as possible are likely to be obtained.
(B) The setting unit 523 preferentially selects the priority αi that has not been selected (because a large reward may be obtained if the priority ai that has not been tested is tested).

### FIG. 7 UCB Method

In order to consider the points (A) and (B), a score called a UCB score pi is defined by the following Equation (1), and the setting unit 523 selects a priority ai having the largest pi at the beginning of each episode as the priority α(t). One episode is a period from a time step of t=1 to a time step of t=n (n is an integer of 1 or more).

$$Math . 1$$

$${μ}_{i} ( T ) = + \sqrt{\frac{log T}{{N}_{i} ( T )}} \qquad ( 1 )$$

In Equation (1), μi (T) on the left side is an average value of the cumulative values of the combined rewards r^{s}(t) of options obtained as a result of selecting the priority ai until the T-th episode.

In Equation (1), a first item on the right side is a latest combined reward average item, that is, an average value of the cumulative values of the combined rewards r^{s}(t) obtained in the episodes in which the priority αi is selected among the last several episodes up to the (T−1) th episode. That is, the latest combined reward average item is considered to be the cumulative value of the combined rewards r^{s}(t) that can be expected when the priority ai is selected.

A second item on the right side is a correction item. Ni in the second item on the right side is the number of episodes in which αi is selected in the latest several episodes up to the (T−1)th episode. The correction item has a larger value as the number Ni of times the priority ai has been selected is smaller.

That is, the selection of the priority ai in which the first item on the right side and the second item on the right side are large, that is, μi (T) is large coincides with the selection of the priority ai in which many combined rewards can be expected and which has not been selected so far.

FIG. 7 is a table illustrating selection results of the priority αi by the UCB method. Specifically, FIG. 7 illustrates the priority selection h history 531 of the priority ai in the latest five episodes and the reward history 532 at that time, the combined reward average item of the first item on the right side and the correction item of the second item on the right side of Equation (1), and the UCB score μi (T=10) at the current episode T=10. Among the UCB scores μi (T=10), the UCB score μ3 (T=10)=“9” of i=3 is a highest score, and thus in the T=10-th episode, a priority α3=9 is selected.

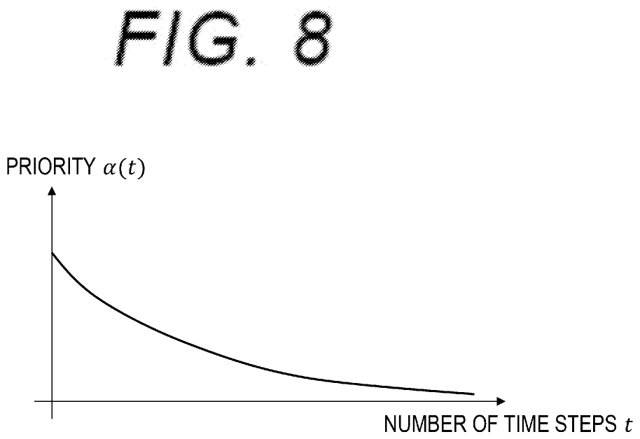

### FIG. 8 Setting Example of Priority α(t)

FIG. 8 is a graph illustrating a setting example of the priority α(t). In FIG. 8, for example, the setting unit 523 sets the priority α(t) according to the number of time steps t by an exponential function or a linear function. Specifically, for example, the setting unit 523 changes the priority α(t) selected by the method illustrated in FIG. 7 according to the number of time steps t by an exponential function or a linear function.

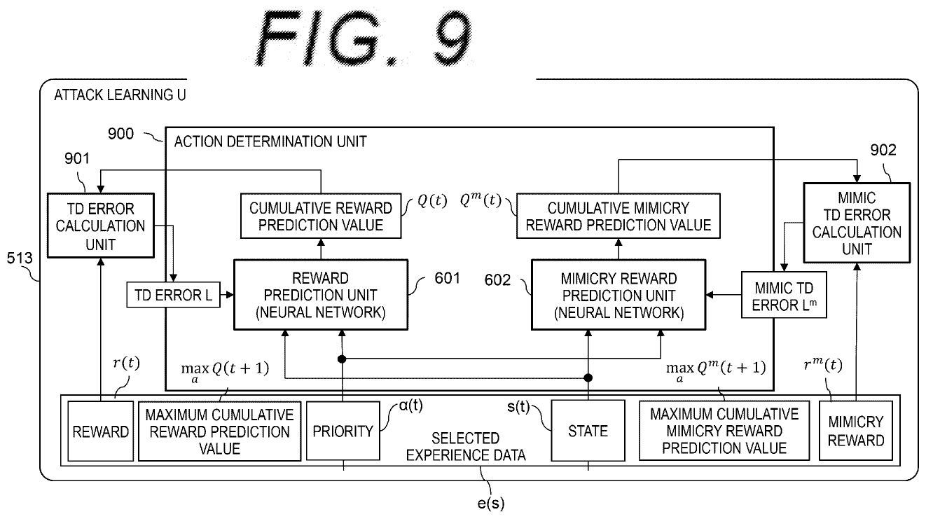

### FIG. 9 Attack Learning Unit 513

FIG. 9 is a block diagram illustrating a detailed functional configuration example of the attack learning unit 513. The attack learning unit 513 includes an action determination unit 900, a TD error calculation unit 901, and a mimicry TD error calculation unit 902. The action determination unit 900 is implemented by removing the calculation unit 603 and the action selection unit 604 from the action determination unit 600.

The attack learning unit 513 optimizes the reward prediction unit 601 and the mimicry reward prediction unit 602 implemented by the neural network so that the cumulative reward prediction value Q(t) and the cumulative mimicry reward prediction value Q^{m}(t) can be accurately predicted.

Specifically, when the weights of the reward prediction unit 601 and the mimicry reward prediction unit 602 that minimize a TD error L defined by the following Equation (2) are obtained for all the experience data e(t), the weights become the optimal policy π(t).

$$Math . 2$$

$$L = E [ \frac{1}{2} {( r ( t ) + γ {max}_{a} Q ( t + 1 ) - Q ( t ) )}^{2} ] \qquad ( 2 )$$

E [ ] in Equation (2) is an expected value of the TD error L, and is, for example, an average value based on a plurality of pieces of experience data e(t) sampled from the experience data group 220. Y on the right side of Equation (2) is a hyperparameter called a time discount rate. r(t) is a reward in the experience data e(t) at the time step t. maxQ(t+1) is a maximum value of a state value function Q at the time step t+1. Q(t) is the state value function Q at the time step t.

Equation (2) is a simplest TD error. In practice, techniques such as importance sampling may be used to appropriately weight each piece of experience data e(t) and remove bias that occurs due to differences between the policy I (t) at the time of experience collection and the policy I (t) at the time of learning. Since the present embodiment does not depend on the equation of the TD error itself, the present embodiment is also applicable to such a derivative technique of the TD error.

Specifically, for example, at the time of learning in the attack learning unit 513, the TD error calculation unit 901 calculates the TD error L by the above Equation (2).

The reward prediction unit 601 updates the weight by learning such that the TD error L is minimized with respect to the cumulative reward prediction value Q(t). As a result, the reward prediction unit 601 is optimized.

Similarly, at the time of learning in the attack learning unit 513, the mimicry TD error calculation unit 902 calculates a mimicry TD error Lm by the following Equation (3) using the cumulative mimicry reward prediction value Q^{m}(t) calculated by the mimicry reward prediction unit 602 and the mimicry reward r^{m}(t) and a mimicry reward prediction value maxQ^{m}(t+1) included in the selected experience data e(s).

$$Math . 3$$

$${L}^{m} = E [ \frac{1}{2} {( {r}^{m} ( t ) + γ {max}_{a} {Q}^{m} ( t + 1 ) - {Q}^{m} ( t ) )}^{2} ] \qquad ( 3 )$$

The mimicry reward prediction unit 602 updates the weight by learning such that the mimicry TD error Lm is minimized with respect to the cumulative mimicry reward prediction value Q^{m}(t). As a result, the mimicry reward prediction unit 602 is optimized.

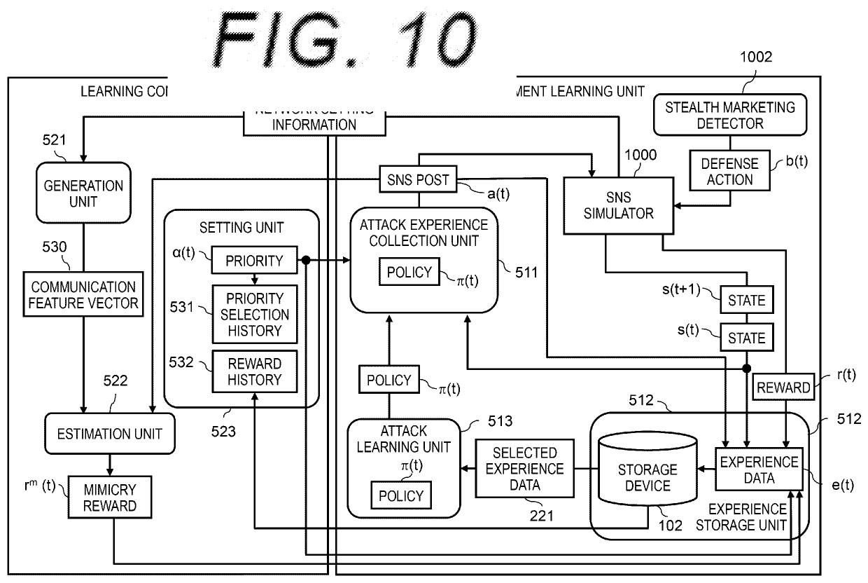

### FIG. 10 Functional Configuration Example 2 of Reinforcement Learning Device 100

FIG. 10 is a block diagram illustrating a functional configuration example 2 of the reinforcement learning device 100. FIG. 10 illustrates s an example in which the reinforcement learning device 100 is applied to a social networking service (SNS) stealth market countermeasure. A difference from FIG. 5 is that a stealth marketing detector 1002 is used as an example of the security countermeasure agent 302, and an SNS simulator 1000 is used as an example of the environment 211.

The stealth marketing detector 1002 is software for detecting stealth marketing. Stealth marketing is a SNS post a(t) that promotes a product or service without disclosing that it is a promotion or advertisement.

Similarly to the network simulator 500, the SNS simulator 1000 is a simulator that simulates a behavior in an intra-organization network indicating a human relation in an organization, a node indicates a personal computer (for example, a smartphone) handled by a person or a server that provides an SNS, and a link indicates a relation between persons, a connection relation between personal computers handled by persons, or a connection relation between a personal computer and a server.

The attack experience collection unit 511 outputs the SNS post a(t) as the attack action a(t). Further, the generation unit 521 generates the communication feature data c(t) related to the SNS post a(t).

As described above, according to the present embodiment, it is possible to reduce learning in which a sparse reward is obtained by the mimicry reward r^{m}(t), and to reduce difficulty in learning. Accordingly, it is possible to preferentially learn an attack imitating normal communication, to deceive the security countermeasure agent 302, and to easily collect good the experience data e(t) necessary for learning.

The invention is not limited to the embodiment described above and includes various modifications and equivalent configurations within the scope of the appended claims. For example, the embodiment described above is described in detail for easy understanding of the invention, and the invention is not necessarily limited to those including all the configurations described above. A part of a configuration of one embodiment may be replaced with a configuration of another embodiment. A configuration of one embodiment may also be added to a configuration of another embodiment. Another configuration may be added to a part of a configuration of each embodiment, and a part of a configuration of each embodiment may be deleted or replaced with another configuration.

A part or all of the above configurations, functions, processing units, processing methods, and the like may be implemented by hardware by, for example, designing with an integrated circuit, or may be implemented by software by, for example, a processor interpreting and executing a program for implementing each function.

Information in a program, a table, a file, or the like for implementing each function can be stored in a storage device such as a memory, a hard disk, or a solid state drive (SSD), or in a recording medium such as an integrated circuit (IC) card, an SD card, or a digital versatile disc (DVD).

Control lines and information lines considered to be necessary for descriptions are shown, and not all control lines and information lines necessary for implementation are shown. Actually, it may be considered that almost all the configurations are connected to one another.

1. A reinforcement learning device comprising:
a generation unit configured to generate a behavior of an environment;
a calculation unit configured to calculate, based on an action on the environment and the behavior generated by the generation unit, a mimicry reward indicating how much the action mimics the behavior;
a collection unit configured to select the action on the environment based on a policy and collect experience data including the action, a state of the environment when the action is performed on the environment, and a reward obtained from the environment as a result of performing the action; and
a learning unit configured to learn the policy based on the reward collected by the collection unit and the mimicry reward calculated by the calculation unit.

2. The reinforcement learning device according to claim 1, wherein
the calculation unit calculates a similarity between the action and the behavior as the mimicry reward.

3. The reinforcement learning device according to claim 1, further comprising
a setting unit configured to set a priority of the mimicry reward, wherein
the learning unit learns the policy based on the priority set by the setting unit.

4. The reinforcement learning device according to claim 3, wherein
the setting unit sets the priority based on the number of repetition times of learning executed by the learning unit.

5. The reinforcement learning device according to claim 1, wherein
the learning unit includes a first reward prediction unit configured to calculate a first cumulative reward prediction value, which is a prediction value of a cumulative value of the reward, based on the reward, and a first mimicry reward prediction unit configured to calculate a first cumulative mimicry reward prediction value, which is a prediction value of a cumulative value of the mimicry reward, based on the mimicry reward, trains the first reward prediction unit such that a difference between the reward and the first cumulative reward prediction value is small, and trains the first mimicry reward prediction unit such that a difference between the mimicry reward and the first cumulative mimicry reward prediction value is small.

6. The reinforcement learning device according to claim 1, further comprising:
an action determination unit configured to determine the action based on the policy when a state of the environment is input.

7. The reinforcement learning device according to claim 6, further comprising:
a setting unit configured to set a priority of the mimicry reward, wherein
the action determination unit determines the action based on the priority and the policy when the priority is input.

8. The reinforcement learning device according to claim 6, wherein
the action determination unit includes a second reward prediction unit configured to calculate a second cumulative reward prediction value, which is a prediction value of a cumulative value of the reward, based on the reward, and a second mimicry reward prediction unit configured to calculate a second cumulative mimicry reward prediction value, which is a prediction value of a cumulative value of the mimicry reward, based on the mimicry reward, and determines the action based on the second cumulative reward prediction value and the second cumulative mimicry reward prediction value.

9. The reinforcement learning device according to claim 8, further comprising:
a setting unit configured to set a priority of the mimicry reward, wherein
the action determination unit determines the action based on the second cumulative reward prediction value and the second cumulative mimicry reward prediction value weighted with the priority when the priority is input.

10. A reinforcement learning method to be executed by a reinforcement learning device, the reinforcement learning device including a processor configured to execute a program and a storage device configured to store the program, the reinforcement learning method comprising:
generation processing, executed by the processor, of generating a behavior of an environment;
calculation processing, executed by the processor, of calculating, based on an action on the environment and the behavior generated in the generation processing, a mimicry reward indicating how much the action mimics the behavior;
collection processing, executed by the processor, of selecting the action on the environment based on a policy and collecting experience data including the action, a state of the environment when the action is performed on the environment, and a reward obtained from the environment as a result of performing the action; and
learning processing, executed by the processor, of learning the policy based on the reward collected in the collection processing and the mimicry reward calculated in the calculation processing.

11. A non-transitory recording medium storing a reinforcement learning program for causing a processor to execute:
generation processing of generating a behavior of an environment;
calculation processing of calculating, based on an action on the environment and the behavior generated in the generation processing, a mimicry reward indicating how much the action mimics the behavior;
collection processing of selecting the action on the environment based on a policy and collecting experience data including the action, a state of the environment when the action is performed on the environment, and a reward obtained from the environment as a result of performing the action; and
learning processing of learning the policy based on the reward collected in the collection processing and the mimicry reward calculated in the calculation processing.
